(19) United States
(12) Patent Application Publication
(10) Pub. No.: US 2007/0045365 A1
(43) Pub. Date: Mar. 1, 2007

(54) CARRYING BAG FOR SUSPENDING ELECTRONIC ENTERTAINMENT APPARATUS

(76) Inventors: Shi-Kun Guo, Shenzhen (CN); Wen-Jie Bao, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,457

(22) Filed: Mar. 28, 2006

(30) Foreign Application Priority Data
Aug. 26, 2005 (CN) 200510036915.9

(51) Int. Cl. B60R 7/00

(52) U.S. Cl. 224/275; 224/929

(57) ABSTRACT

A carrying bag is employed for suspending an electronic entertainment apparatus in a vehicle having at least one seat. The electronic entertainment apparatus including a main body, a display unit pivotally coupled to the main body. The carrying bag includes a bag body for accommodating the main body therein, a bag cover for accommodating the display unit therein, and at least one fastening band. The bag cover rotatably coupled to the bag body. The fastening band connects the bag body and the cover for detachably encircling the seat.

### FIELD OF THE INVENTION

The present invention relates to a carrying bag and, more particularly, to a carrying bag for suspending an electronic entertainment apparatus.

### DESCRIPTION OF RELATED ART

Electronic entertainment apparatuses, such as disk players and notebook computers, have become increasingly lighter and more compact. Technologies are currently available to enable the disk players and other electronic entertainment apparatuses to be portable. To take advantage of these advances in technology, various carrying bags have been developed for the electronic entertainment apparatuses to be transported by individuals or used in vehicles.

Referring to FIGS. 5 and 6, two kinds of portable players 80, 82 are illustrated. The portable player 80 is bar-shaped and includes a main body 800 and a display unit 802. When the portable disk player 80 is in use, a whole backside of the display unit 802 is combined to the main body 800. A front of the display unit 802 faces outwards. The portable player 82 is foldable-shaped and includes a main body 820, a hinge assembly 822 and a display unit 824. The display unit 824 is pivotally coupled to the main body 820 via the hinge assembly 822. During use, the display unit 824 is opened and maintained at any desired position relative to the main body 820.

Referring to FIG. 5 again, a carrying bag 70 for securing the portable disk player 80 onto a seat 90 in a vehicle (not shown) is illustrated. The carrying bag 70 includes a bag body 700 for receiving the portable disk player 80, two fastening belts 702 positioned at a front of the bag body 700 for securing the portable disk player 80 in the bag body 700, and a plurality of fastening bands 704 formed on a backside of the bag body 700 for securing the bag body 700 onto a headrest 902 of the seat 90. Only one bag body 700 is needed for receiving the portable disk player 80 therein. In case a foldable portable disk player 82 replaces the portable disk player 80, there is not enough space for accommodating both a main body 820 and a display unit 824 in the carrying bag 70. This is because the display unit 824 is opened relative to the main body 820 when the portable disk player 82 is in use.

Referring to FIG. 6 again, another carrying bag 72 for suspending the portable disk player 82 between two seats 92 in a vehicle (not shown) is illustrated. The carrying bag 72 includes a bag body 720 for receiving the main body 820, a fastening belt 722 for securing the main body 820 in the bag body 720, and a plurality of fastening bands 724 interconnecting two opposite sides of the bag body 720 thereby bonding the bag body 720 to the two seats 92. The display unit 824 is entirely exposed and completely depends on the support of the hinge assembly 822. The portable disk player 82 is likely to be dysfunctional because the hinge assembly 822 is liable to be broken when vibrations in response to motion of the vehicle is too great.

Therefore, a carrying bag with a steady protection structure for suspending an electronic entertainment apparatus is desired.

### SUMMARY OF INVENTION

A carrying bag is employed for suspending an electronic entertainment apparatus in a vehicle having at least one seat. The electronic entertainment apparatus including a main body, a display unit pivotally coupled to the main body. The carrying bag includes a bag body for accommodating the main body therein, a bag cover for accommodating the display unit therein, and at least one fastening band. The bag cover rotatably coupled to the bag body. The fastening band connects the bag body and the cover for detachably encircling the seat.

Other advantages and novel features will become more apparent from the following detailed description of preferred embodiments when taken in conjunction with the accompanying drawings, in which:

### BRIEF DESCRIPTION OF DRAWINGS

FIG. 1 is an isometric view of a carrying bag for suspending an electronic entertainment apparatus in accordance with an exemplary embodiment, with a cover being opened;

FIG. 2 is similar to FIG. 1, but viewed from another aspect;

FIG. 3 is an isometric view of the carrying bag of FIG. 1, with a cover being closed and fastening bands being removed;

FIG. 4 is an isometric view of the carrying bag of FIG. 1 attached onto a headrest of a seat, with an electronic entertainment apparatus accommodated therein;

FIG. 5 is an isometric view of a conventional carrying bag for suspending an electronic entertainment apparatus; and

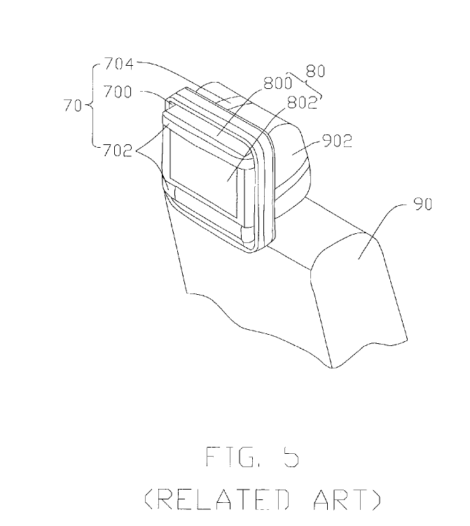

FIG. 6 is an isometric view of another conventional carrying bag for suspending an electronic entertainment apparatus.

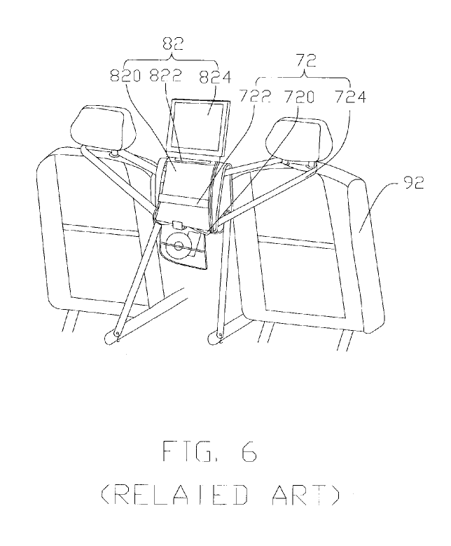

### DETAILED DESCRIPTION

Electronic entertainment apparatuses of the present invention can be foldable disk players, notebook computers, and other electronic entertainment apparatuses. In the following embodiments, a foldable disk player is used as an example for illustration.

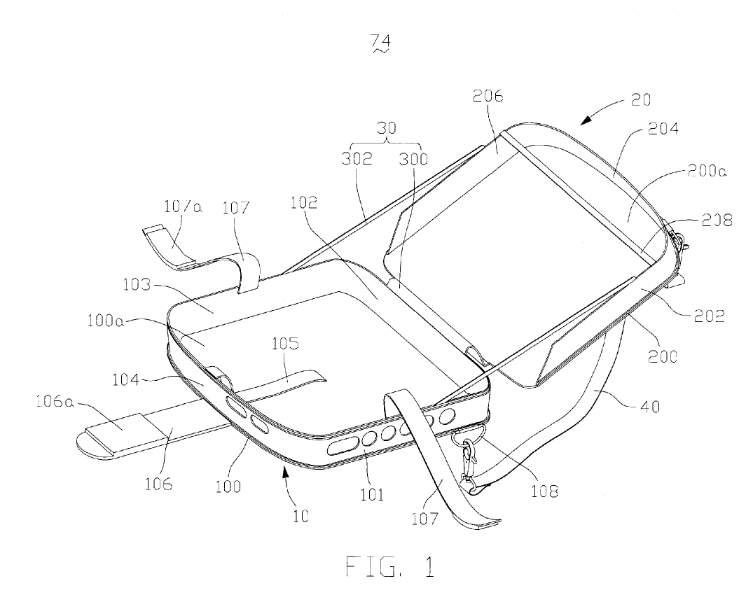

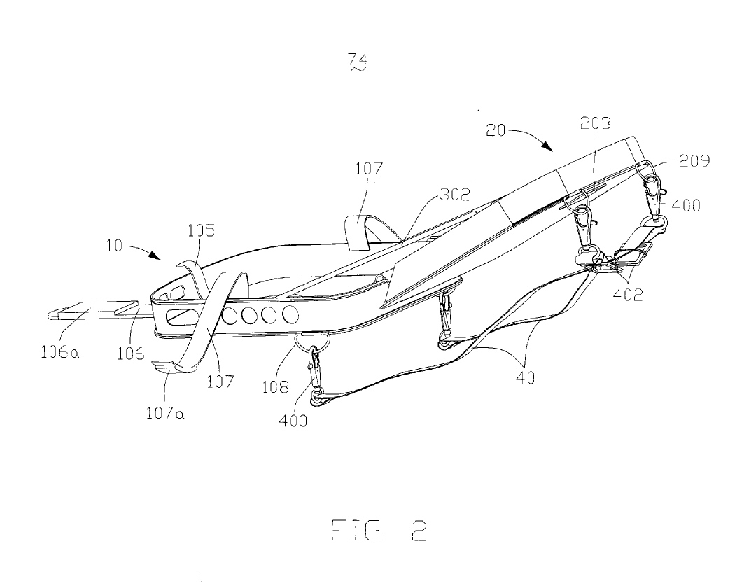

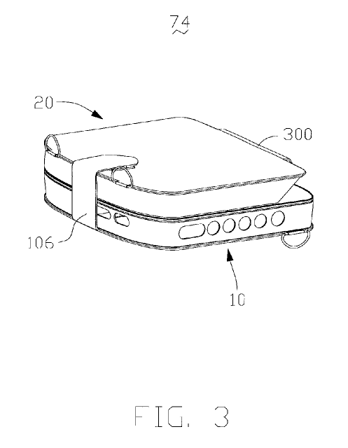

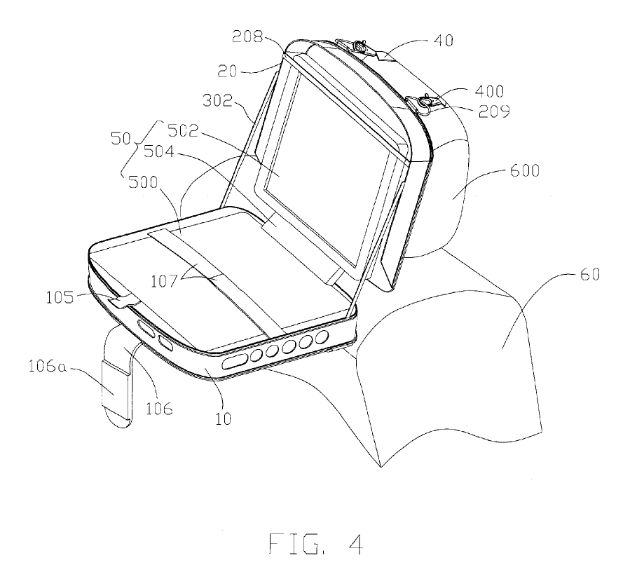

Referring to FIGS. 1 to 4, a carrying bag 74 according to a preferred embodiment is illustrated. The carrying bag 74 for suspending a general foldable disk player 50 (shown in FIG. 4) in a vehicle (not shown) includes a bag body 10, a bag cover 20 rotatably coupled to the bag body 10, a connecting portion 30 for interconnecting the bag body 10 and the bag cover 20, and a pair of fastening bands 40 for fastening both the bag body 10 and the bag cover 20 onto a seat 60 in the vehicle. The foldable disk player 50 generally includes a main body 500 accommodating various electronic components therein (e.g. an optical disk recording/reproducing module), a display unit 502 for displaying images/pictures signals transmitted from the main body 500, and a hinge assembly 504. The main body 500 and the display unit 502 are pivotally connected via the hinge assembly 504.

The bag body 10 includes a bottom 100, first, second, third, and fourth bottom-walls 101, 102, 103, and 104 extending a predetermined distance from a periphery of the bottom 100. The first, second, third, and fourth bottom-walls 101, 102, 103, and 104 cooperate with the bottom 100 to construct a first chamber 100a for accommodating the main body 500 therein.

A lifting band 105 adheres to the bottom 100 with its one free end extending out from an inter-space between the main body 500 and the fourth bottom-wall 104. A first fastening belt 106 connects to the bottom 100 or the fourth bottom-wall 104, with a first affixing patch 106a attached to a free end thereof for locking the bag body 10 and the bag cover 20 together. A pair of second fastening belts 107 respectively connects to the first and third bottom-walls 101 and 103 that detachably affixes to each other with a pair of second affixing patches 107a correspondingly positioned on their free ends so as to hold the main body 500 in the first chamber 100a. A pair of first D-rings 108 locates at two opposite sides of the bottom 100 and is respectively adjacent to the first and third bottom-walls 101, 103.

The bag cover 20 includes a top 200, first, second, and third top-walls 202, 204, and 206 extending a predetermined distance from a periphery of the top 200 to construct a second chamber 200a together with the top 200 for accommodating the display unit 502 therein. The first, second, and third top-walls 202, 204, and 206 respectively correspond to the first, fourth, and third bottom-walls 101, 104, and 103.

A third affixing patch 203 is attached on an outer surface of the top 200 for detachably affixing the first affixing patch 106a. A pair of second D-rings 209 locates at a side of the top 200, and is adjacent to the second top-wall 204. A third fastening belt 208 connects the first and second top-walls 202 and 206 with its two opposite ends for securing the display unit 502 in the second chamber 200a. The third fastening belt 208 is close to the second top-wall 204 for preventing images or pictures shown on the display unit 502 from being obstructed.

The connecting portion 30 for interconnecting the bag body 10 and the bag cover 20 includes a flexible connecting flap 300 and a pair of pulling bands 302. The flexible connecting flap 300 connects the second bottom-wall 102 to the side of the top 200 proximate to the second bottom-wall 102. One of the pair of pulling bands 302 interconnects the first bottom-wall 101 and the first top-wall 202. The other pulling band 302 interconnects the third bottom-wall 102 and the third top-wall 206. The pair of pulling bands 40 is used for preventing the display unit 502 from over rotating relative to the main body 500.

Each fastening band 40 includes a pair of releasable hooks 400 at two ends thereof for clasping the corresponding diagonal first and second D-rings 108 and 209, and an adjustable buckle 402 for adjusting a length of the fastening band 40.

The display unit 502 needs to be opened relative to the main body 500 before the foldable disk player 50 is put into the carrying bag 74. The main body 500 is placed into the first chamber 100a. The pair of second fastening belts 107 connects to each other via the second affixing patches 107a, thus the main body 500 is secured. The lifting band 105 extends out from the inter-space between the main body 500 and the fourth bottom-wall 104. The display unit 502 is accommodated in the second chamber 200a, and secured by the third fastening belt 208. The pair of fastening bands 40 is placed crosswise to each other, and respectively clasps the first and second D-rings 108 and 209 via the releasable hooks 400 thereof.

The assembly of the carrying bag 74 and the foldable disk player 50 may be firmly attached to a headrest 600 of the seat 60 with the pair of fastening bands 40 encircling the headrest 600. A degree of tightness of the pair of fastening bands 40 may be adjusted by the adjustable buckles 402 to urge the carrying bag 74 into contact with the headrest 600 of the seat 60. The pulling bands 302 pull the bag body 10 relative to the bag cover 20 for keeping the bag body 10 and the bag cover 20 in position. Supporting force provided by the fastening bands 40 and the pulling bands 302 balances the weight of the foldable disk player 50. The third fastening belt 208 secures the display unit 502 and prevents it from swaying. The second fastening belts 107 secure the main body 500 and prevent it from swaying. Therefore, the foldable disk player 50, especially the hinge assembly 504, is steadily protected and not liable to be damaged.

It should be noted that a shape of the carrying bag 74 is designed according to a shape of the electronic entertainment apparatus accommodated therein. The shape of the carrying bag 74 could alternatively be a cycloid, cartouche or other non-rectangular shapes. Correspondingly, the number of the bottom-walls and top-walls are not limited to the above-described embodiment. In addition, one of the second fastening belts 107 could be omitted. The second affixing patches 107a on the omitted second fastening belt 107 could be optionally replaced on the third bottom-wall 103 or an outer surface of the bottom 100. The reserved second fastening belt 107 could be lengthened to affix the replaced second affixing patch 107a. Adjustability of the fastening bands 40 that encircle the headrest 600 of seat 60 may be achieved by various adjustable members that are known to those skilled in the art, besides the adjustable buckles 402. It is understood that instead of the first, second, and third affixing patches 106a, 107a, and 203, other types of detachable connecting configurations may be used, such as male and female snap members, hook and loop members, metal clips, magnets, buttons and so on. Furthermore, the coupling configurations described above can also be used as coupling members and releasable coupling members instead of the first and second D-rings 108, 209, and the releasable hooks 400. The bag body 10 and the bag cover 20 may be coupled to each other directly or by means of various connecting members such as the flexible connecting flap 300.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A carrying bag for suspending an electronic entertainment apparatus on a seat, the electronic entertainment apparatus including a main body and a display unit pivotally coupled to the main body, the carrying bag comprising:
a bag body for accommodating the main body therein;
a bag cover rotatably coupled to the bag body for accommodating the display unit therein; and
at least one fastening band connecting the bag body to the bag cover for detachably encircling the seat.

2. The carrying bag as claimed in claim 1, wherein a plurality of fastening belts are respectively detachably attached to the sides of the bag body and the bag cover for fastening the main body and the display unit.

3. The carrying bag as claimed in claim 1, wherein at least two first coupling members are attached to at least one side of the bag body, and at least one second coupling member is attached to another side of the bag cover opposite to a side of the bag cover joining the bag body.

4. The carrying bag as claimed in claim 3, wherein the fastening band comprises releasable coupling members thereof for fastening the first and second coupling members, and an adjustable member for adjusting a length of the fastening band.

5. The carrying bag as claimed in claim 1, further comprising a pair of pulling bands substantially symmetrically positioned on two opposite sides of the carrying bag, each pulling band interconnecting the bag body and the bag cover on the same side to keep the bag body and the bag cover in position.

6. The carrying bag as claimed in claim 1, wherein the bag body includes a lifting band for lifting the main body out of the bag body, the lifting band has a fixed end attached to the main body, and an opposite free end extended out from an inter-space between the main body and the bag body.

7. The carrying bag as claimed in claim 1, wherein the bag cover rotatably coupled to the bag body via at least one connecting member.

8. A carrying bag for suspending an electronic entertainment apparatus in a seat, the electronic entertainment apparatus including a main body, and a display unit pivotally coupled to the main body, the carrying bag comprising:
a bag body including a bottom, a plurality of bottom-walls extending from a periphery of the bottom, and at least one fastening belt connecting two bottom-walls for securing the main body, the bottom cooperating with the bottom-walls to construct a first chamber for accommodating the main body therein;
a bag cover rotatably coupled to the bag body including a top, a plurality top-walls extending from a periphery of the top, and at least one fastening belt connecting two top-walls for securing the display unit, the top cooperating with the top-walls to construct a second chamber for accommodating the display unit therein; and
at least one fastening band connecting the bag body to the cover, for detachably encircling the seat.

9. The carrying bag as claimed in claim 8, wherein a plurality of fastening belts are respectively detachably attached to the bottom-walls and the top-walls for fastening the main body and the display unit.

10. The carrying bag as claimed in claim 8, wherein at least two first coupling members are attached to at least one side of the bottom, and at least one second coupling member is attached to another side of the top opposite to a side of the bag cover joining the bag body.

11. The carrying bag as claimed in claim 10, wherein the fastening band comprises releasable coupling members thereof for fastening the first and second coupling members, and an adjustable member for adjusting a length of the fastening band.

12. The carrying bag as claimed in claim 8, further comprising a pair of pulling bands substantially symmetrically positioned on two opposite side of the carrying bag, each pulling band interconnecting the bottom-wall and the top-wall which are on the same side to keep the bag body and the bag cover in position.

13. The carrying bag as claimed in claim 8, wherein the bag body includes a lifting band for lifting the main body out of the bag body, the lifting band has a fixed end attached to the bottom, and an opposite free end extended out from an inter-space between the main body and another bottom-wall opposite to the bottom-wall connecting the bag cover.

14. The carrying bag as claimed in claim 8, wherein the bag cover pivotally coupled to the bag body via at least one connecting member.

15. A suspending system for removably securing an electronic entertainment apparatus in a vehicle, comprising:
an electronic entertainment apparatus including a main body for processing and transmitting signals,
a display unit pivotally coupled to the main body via a hinge assembly for receiving and displaying the signals from the main body; and
a carrying bag including a bag body, a bag cover rotatably coupled to the bag body, and at least one fastening band, the bag body including a bottom, a plurality of bottom-walls extending from a periphery of the bottom, and at least one fastening belt connecting two bottom-walls for securing the main body, the bottom cooperating with the bottom-walls to construct a first chamber for accommodating the main body therein, the bag cover rotatably coupled to the bag body including a top, a plurality top-walls extending from a periphery of the top, and at least one fastening belt connecting two top-walls for securing the display unit, the top cooperating with the top-walls to construct a second chamber for accommodating the display unit therein, the fastening band connecting the bag body to the cover, for detachably encircling the seat.

16. The suspending system as claimed in claim 15, wherein a plurality of fastening belts are respectively detachably attached to the bottom-walls and the top-walls for fastening the main body and the display unit.

17. The suspending system as claimed in claim 15, wherein at least two first coupling members are attached to at least one side of the bottom, and at least one second coupling member is attached to another side of the top opposite to a side of the bag cover joining the bag body.

18. The suspending system as claimed in claim 17, wherein the fastening band comprises releasable coupling members thereof for fastening the corresponding first and second coupling members, and an adjustable member for adjusting a length of the fastening band.

19. The suspending system as claimed in claim 15, further comprising a pair of pulling bands substantially symmetrically positioned on two opposite side of the carrying bag, each pulling band respectively attached to the bottom-wall and the top-wall which are on the same side to keep the bag body and the bag cover in position.

20. The suspending system as claimed in claim 15, wherein the bag body includes a lifting band for lifting the main body out of the bag body, the lifting band has a fixed end attached to the bottom and an opposite free end extended out from an inter-space between the main body and another bottom-wall opposite to the bottom-wall connecting the bag cover.
